(19) United States
(12) Patent Application Publication
(10) Pub. No.: US 2026/0029294 A1
(43) Pub. Date: Jan. 29, 2026

(54) Low-Power Toilet Leak Detection System

(71) Applicant: Brett Earnest, Longview, WA (US)

(72) Inventor: Brett Earnest, Longview, WA (US)

(21) Appl. No.: 19/283,111

(22) Filed: Jul. 28, 2025

Related U.S. Application Data
(60) Provisional application No. 63/676,858, filed on Jul. 29, 2024.

(51) Int. Cl. G01M 3/18; E03D 9/00

(52) U.S. Cl. CPC G01M 3/183; E03D 9/00

(57) ABSTRACT

A system that detects water leaking under a toilet to prevent water damage. The system uses an adapter plate with a wick that draws water by capillary action, upward to the toilet base. A cap assembly houses a printed circuit board, enclosed by a removable cover made of light-diffusing material or including an optional viewing window. The wick connects to two pins mounted on the printed circuit board. The printed circuit board includes a battery connected to a battery monitoring circuit and a wick resistance monitoring circuit. Both circuits include MOSFETs and additional circuits that cause a first LED to slowly blink only when the battery voltage is below a set threshold causing a second LED to blink only when electrical resistance in the wick is below a set threshold, thereby minimizing the amount of voltage used. To ensure conductivity, a dry conductive agent may be added to the wick.

This patent application is based on and claims the filing date benefit of U.S. provisional patent application (Application No. 63/676,858), filed on Jul. 29, 2024.

### FIELD AND BACKGROUND OF THE INVENTION

### Field of the Invention

This invention pertains to devices or systems used to detect hidden water leaks from a toilet.

### Background of the Invention

Wax rings or wax seals are usually sufficiently thick and malleable to form a water-tight seal between the toilet base and the toilet flange plate (also called a ‘closet flange’) when the toilet base is properly set and tightened to the toilet flange plate. If the toilet base is not properly set over the toilet flange plate or if the toilet base moves after installation, wastewater may leak between the wax ring and the toilet flange causing damage to the subfloor. Because the subfloor area under the toilet plate flange is hidden, water leaking can go undetected for months and years.

What is needed is a water leak detection system that can be used with a standardized toilet wax or rubber seal that presses against the bottom surface of the toilet flange plate that detects water leaks.

### SUMMARY OF THE INVENTION

A low-power leak detection system used with a toilet is used to detect water leaking under the toilet. The system uses a leak-detection toilet adapter plate to attach a toilet to the subfloor. The adapter plate includes an outer gutter containing a wick that fits into a gutter and then bends extends upward into a toilet bolt hole formed on the toilet base as shown in U.S. Pat. No. 11,454,015, now incorporated by reference. When water contacts the wick, the water travels up the entire wick via capillary action.

The system also includes a cap assembly that interfaces with the upper end of wick that extends upward from the toilet adapter plate and through the bolt hole formed on the toilet base. The cap assembly includes a printed circuit board with two pins that are embedded into the upper end of the wick.

The printed circuit board includes a coin battery connected to a battery monitoring circuit and a wick resistance monitoring circuit. The battery monitoring circuit includes a low battery detection circuit, a first MOSFET, a low battery flasher circuit, and a first LED. The low battery detection circuit monitors the battery's voltage. When the battery voltage is below a set threshold, a signal is sent to the first MOSFET which activates the low battery flasher circuit. The low battery flasher circuit causes the first LED to slowly blink.

The printed circuit board is designed to fit around the toilet bolt used to secure the toilet base to the floor. When the lower end of the wick comes into contact with water, water is drawn upward into the wick via capillary action and reaches the upper end located between the two pins. The two pins are connected to a wick resistance detection circuit, which monitors the resistance at the end of the wick between the two pins. When water is present at the end of the wick, electrical resistance in the wick is reduced below a set threshold. The wick resistance detection circuit is connected to the second MOSFET, which activates a leak detection flasher circuit. The leak detection flasher circuit causes the second LED to blink.

The leak detection flasher circuit may also be attached to a transducer that produces an audible sound when water is detected in the wick. The leak detection flasher circuit may be connected to an optional Wifi or Bluetooth Controller that transmits a wireless signal to a compatible remote device.

To improve electrical conductivity and capillary movement in the wick, the wick may be covered with a dry conductivity agent.

The printed circuit board is mounted on a lower plate that attaches to the top surface of the toilet base. A removable cover fits over and attaches to the lower plate, preventing water from coming into contact with the printed circuit board. The cover may be made of a light-diffusing material or include an optional viewing window, enabling a clearer view of the LEDs.

Because the first LED only blinks slowly when the battery voltage drops below a threshold voltage, and the second LED blinks slowly only when the wick's resistance reaches a threshold resistance, the LEDs remain OFF, indicating the battery voltage is sufficient and no water is detected, thereby preserving battery voltage.

### BRIEF DESCRIPTION OF DRAWINGS

FIG. 1 is an exploded perspective view of the cap assembly being assembled over the toilet flange on a toilet base.

FIG. 2 is a perspective view of the cap assembly with the cover removed positioned over the toilet flange and showing the wick being attached to a set of pegs.

FIG. 3 is a perspective view of the adapter plate with two toilet bolts extending upward from the adapter plate and showing a wick located adjacent to one toilet bolt.

FIG. 4 is a sectional side elevational view of the cap assembly.

FIG. 5 is a top plan view of the cap assembly shown in FIG. 4.

FIG. 6 is a schematic showing a printed circuit board with a battery monitoring circuit and a wick resistance detection circuit.

FIG. 7 is a state table showing the different system's input conditions or states and the corresponding outputs or behaviors

### DETAILED DESCRIPTION OF THE INVENTION

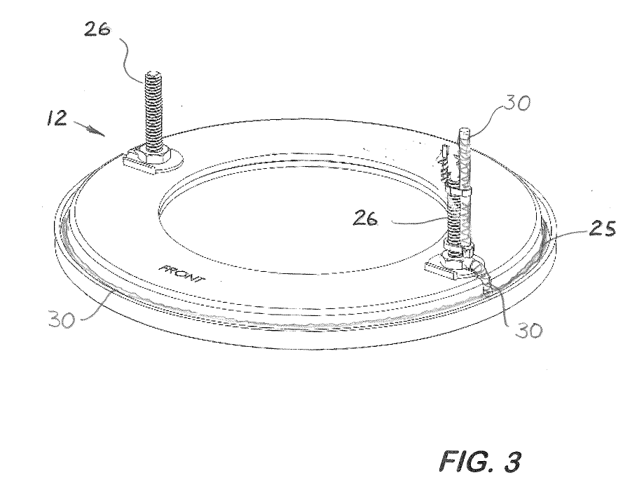

A toilet cap leak detection system 10 for a toilet 90 that uses with a wick 30 that draws water caused by water leaking onto an adapter plate 12 shown in U.S. Pat. No. 11,454,015, now incorporated by reference. The system 10 uses an adapter plate 12 shown in FIG. 3, with two toilet bolts 26 used to hold the toilet base 95 to the floor. The adapter plate 12 includes a circular outer gutter 25 that contains a wick 30. During assembly, an elongated wick 30 is inserted into the outer gutter 25, with one end exposed and extending upward alongside one of the toilet bolts 26. When water leaks onto the wick, it travels the entire length of the wick.

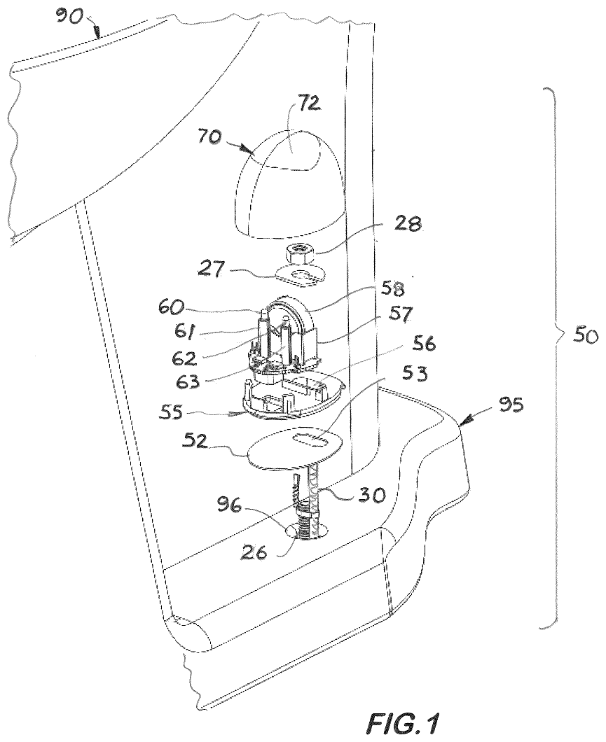

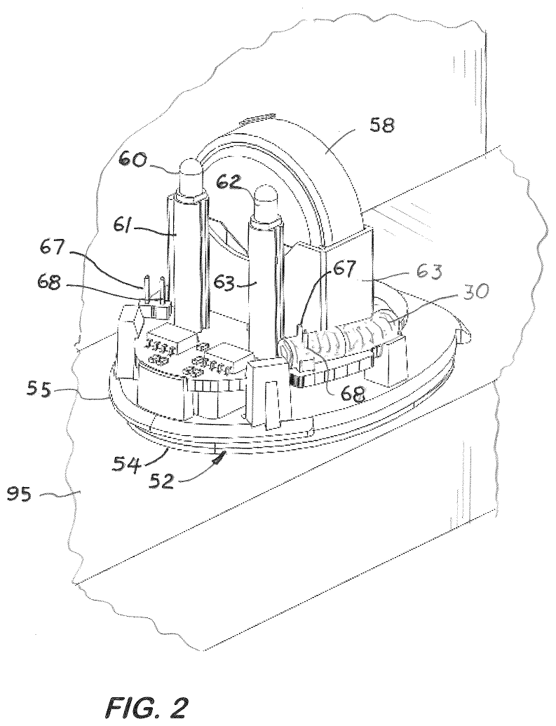

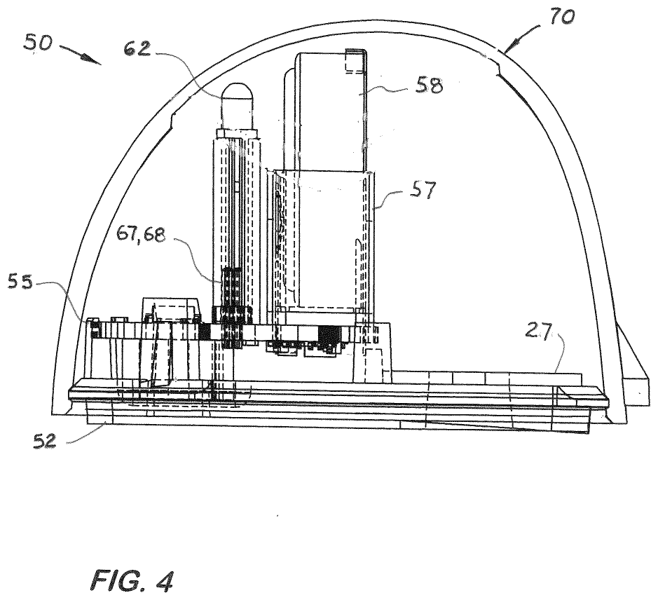

The system 10 also includes a cap assembly 50, shown in FIGS. 1, 2, 4, and 5, configured to attach to the end of the wick 30 that extends upward from adapter plate 12 and through the toilet base 95. The wick 30 extends into the cap assembly 50 and connects to two sets of parallel pins 67, 68 located on opposite sides of the printed circuit board 55. It should be understood that one pair of pins 67, 68 may be used. The printed circuit board 55 is located over a lower alignment plate 52. An adhesive may be applied to the bottom of the alignment plate 52 to hold it in place on the toilet base 95.

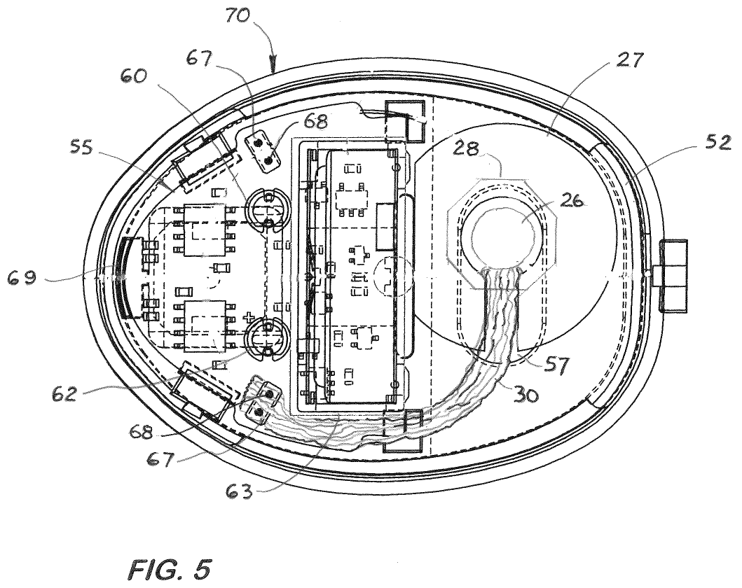

The alignment plate 52 includes a slotted hole 53 that extends around toilet bolt 26 and wick 30 as shown in FIG. 5. During use, slotted hole 53 is aligned and registered with a bolt hole 96 formed on the toilet base 95. A slotted washer 27 and a nut 28 are attached to the end of toilet bolt 26 that extends above the toilet flange 95. As shown in FIG. 3, the upper section of wick 30 may be attached to bolt 53 with a zip tie. When the wick 30 contacts water, water is drawn into the cap assembly 50 and into the upper section of the wick 30 located between the two pins 67 and 68.

Mounted on the printed circuit board 55 is a battery holder 57 configured to hold an exchangeable coin battery 58, which energizes the printed circuit board 55 and the electrical circuits and components located thereon.

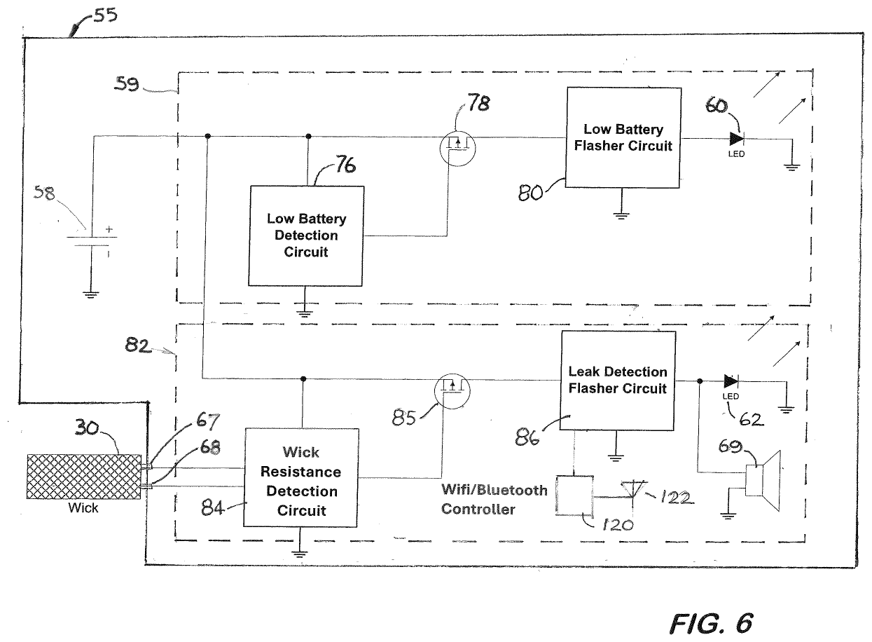

As shown in FIG. 6, the printed circuit board 55 includes a battery monitoring circuit 59 and a wick resistance monitoring circuit 82. The battery monitoring circuit 59 includes a low battery detection circuit 76, a first MOSFET 78, a low battery flasher circuit 80, and a first LED 60. During use, the low battery detection circuit 76 monitors the battery's voltage. When the battery voltage is below a set threshold, a signal is sent to the first MOSFET 78, which activates the low battery flasher circuit 80. The low battery flasher circuit 80 causes the first LED 60 (RED) to slowly blink. (once every 30 seconds). The leak detection flasher circuit 80 may be connected to an optional Wifi or Bluetooth Controller 120 connected to an antenna 122 that transmits a wireless signal to a compatible remote device (not shown).

The two pins 67 and 68 mounted and on the printed circuit board 55 are connected to a wick resistance detection circuit 84, which monitors the resistance at the end of the wick 30 between the two pins 67, 68. When water is present at the end of the wick 30, electrical resistance in the wick 30 is reduced below a set threshold. The wick resistance detection circuit 84, which detects an increase in voltage between the two pins 67, 68 and activates a second MOSFET 85. The second MOSFET 85 activates a leak detection flasher circuit 86 which causes the second LED (YELLOW) 62 to blink. (once every 5 seconds). A transducer 69 may be included that generates an audible sound.

Attached to the alignment plate 52 is removable cover 70 made of transparent or opaque material that enables the user to view the LEDs 60, 62. The LEDs 60 and 62 may be mounted on columns 61, 63 to improve visibility. An optional lens 72 may be formed in cover 70 to improve visibility of the two LEDs 60, 62.

Electrical resistance of water varies depending on the solutes, such as salts or minerals, dissolved in the water. For example, the electrical resistance of distilled water is high because it lacks ions that conduct electricity. Even tap water varies significantly depending on mineral and chemical composition, which can differ by region, source, and treatment process. To ensure that absorbed water has consistently lower resistance, the wick 30 may be soaked with an electrical conduction agent, such as sodium chloride, potassium chloride, sodium bicarbonate, calcium chloride, or magnesium sulfate.

The pins 67 and 68 are 2 to 4 mm apart, and the wick 30 is approximately 5 to 6 mm in diameter and made of hydrophilic material such as cellulose, cotton, or synthetic fiber. It should be understood other sizes of wick 30 may be used. The length of the wick 30 must be sufficient to extend into the outer gutter 25 on the adapter plate 12 and extend upward through the toilet base 95 and engage pins 67 and, 68. The wick 30 may be infused with a salt-based electrolyte that enhances electrical conductivity and possibly improves capillary action. The amount of salt-based electrolyte should be low to moderate concentration (0.1 to 0.5 grams per 10 ml of water, making a 1-5% weight/volume (w/v) concentration. During manufacturing, the wick 30 is lightly saturated with the solution and then dried leaving a thin, even salt residue. Examples of salt-based electrolytes that may be used include sodium chloride, potassium chloride, calcium chloride, magnesium sulfate, and lithium chloride.

The low battery detection circuit 76, which is part of the battery monitoring circuit 59 and monitors the voltage level of the coin battery 58, (e.g., a 3.0V). The primary function of the low battery detection circuit 76 is to detect when the battery voltage drops below a predefined threshold, typically around 2.7 volts. During operation, the low battery detection circuit 76 continuously measures voltage. When the battery voltage falls below the set threshold (2.7 V) the low voltage is detected and the low battery detection circuit 76 sends a signal to the gate on the first MOSFET 78. The first MOSFET 78, acting as a high-side switch, receives the output signal from the low battery detection circuit 76 and activates the low battery flasher circuit 80 which controls the blinking of LED 60.

The wick resistance monitoring circuit 82 includes a wick resistance detection circuit 84 used to measure the resistance at the end of wick 30 between the two pins 67 and 68. When resistance at the end of the wick drops below a predefined threshold (e.g., 2.2 Mohms) due to moisture in the wick 30, the wick resistance detection circuit 84 outputs a signal. The signal is sent to a second MOSFET 85. The second MOSFET 85, also acting as a high-side switch, receives the output signal from the wick resistance detection circuit 84 and sends a signal to the leak detection flasher circuit 86, which controls activation of the second LED 62 and/or the transducer 69.

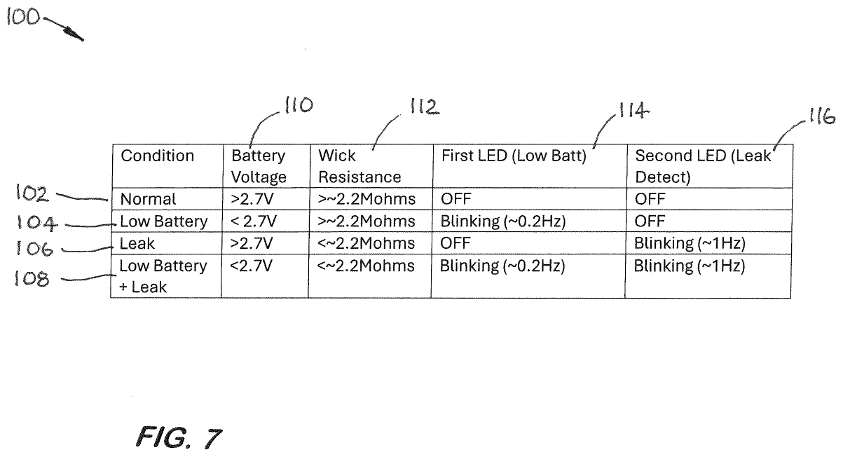

FIG. 7 is a state table 100 summarizing how system 10 responds to four different environmental states: a normal state 102, a low battery state 104, a leak detected state 106, and a low battery+leak state 108. Presented in table 100 are columns that show the battery voltage 110, the wick resistance 112, the first LED state 114 and the second LED state 116 according to the environmental states 102-108. For example, table 100 clearly indicates that both the first LED 60 and the second LED 62 are OFF when the voltage of the battery 66 is greater than 2.7 V and no moisture is presented in the wick 30. By maintaining the two LEDs 60, 62 in an OFF state when the battery 58 has voltage above the set threshold and no moisture is detected between the pins 67, 68, the system 10 to reserve battery voltage. When the voltage in the battery 66 drops below the threshold voltage (2.7 V0, and no moisture is detected, only the first LED 60 blinks. When the first LED 60 begins blinking and then stops, the user understands that the voltage in the battery 58 is critically low and that it should be replaced.

When the battery voltage is at or greater than the threshold voltage (2.7 V), and moisture is detected in the wick 30, the first LED 60 remains OFF and the second LED 62 blinks. The user should investigate why the wick 30 contains moisture. When the battery voltage drops below 2.7 V, however, and water is detected in the wick 30 (resistance <2.2 Mohms), both the first LED 60 and the second LED 62 blink. This informs the user that the battery voltage is low, and moisture is detected in the wick 30.

As mentioned above, in the embodiment presented the first LED 60 is YELLOW and the second LED 62 is RED. It should be understood that the LEDs may be different colors. Also, when activated, the first LED 60 is designed to blink at a duty cycle of 0.2 Hz while the second LED 62 is designed to blink at 1 Hz, which conserves battery power while providing visible, periodic feedback to the reviewer. It should also be understood that other duty cycles may be used

In compliance with the statute, the invention described has been described in language more or less specific as to structural features. It should be understood, however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

1. An electronic water detection device comprising:
a. a first MOSFET coupled to a power supply and configured as a high-side switch to control a first LED;
b. a low battery flasher circuit electrically connected to the gate of the first MOSFET and configured to activate the first LED when the supply voltage falls below a predefined threshold;
c. a second MOSFET configured as a high-side switch to control a second LED;
d. a wick resistance monitoring circuit including a pair of pins disposed within an absorbent wick and electrically connected to the gate of the second MOSFET, the wick resistance monitoring circuit being configured to activate the second LED when electrical resistance between the pins falls below a predefined threshold; and,
e. wherein the first and second MOSFETs operate independently to indicate low battery voltage and the presence of moisture, respectively.

2. The device of claim 1, wherein the first MOSFET activates the first LED when the supply voltage falls below approximately 2.7 volts.

3. The device of claim 1, wherein the second MOSFET activates the second LED when the electrical resistance between the electrodes falls below approximately 2.2 Mohms.

4. The device of claim 1, wherein the wick comprises a hydrophilic material that draws water through capillary action.

5. The device of claim 1, wherein the wick is infused with a salt-based electrolyte to reduce electrical resistance when wet.

6. The device of claim 1, further including a leak detection flasher circuit located between the second MOSFET and the second LED.

7. The device of claim 6, further including a WIFI or BLUETOOTH controller connected to the leak detection flasher circuit.

8. The device of claim 1, wherein the power supply is a 3.0-volt coin cell battery.

9. The device of claim 1, wherein the moisture detection circuit and voltage detection circuit are mounted on a printed circuit board.

10. The device of claim 8, wherein the printed circuit board is positioned on the base of a toilet, and the wick extends upward from an adapter plate located beneath the toilet, such that the wick is in fluid communication with moisture accumulating below the toilet and electrically connected to the moisture detection circuit.

11. The device of claim 9, further comprising a protective cover enclosing the printed circuit board, the cover being formed from light-transmissive material or comprising a window aligned with one or more LEDs, such that illumination from the LEDs is visible through the cover.

12. The device of claim 8, wherein the printed circuit board is positioned on the base of a toilet, and the wick extends upward from an adapter plate located beneath the toilet, such that the wick is in fluid communication with moisture accumulating below the toilet and electrically connected to the moisture detection circuit.

13. (canceled)

14. (canceled)

15. An electronic water detection device comprising:
a. a first MOSFET coupled to a 3.0-volt coin cell battery and configured as a high-side switch to control a first LED;
b. a voltage monitoring circuit electrically connected to the gate of the first MOSFET and configured to activate the first LED when the supply voltage falls below approximately 2.7 volts;
c. a second MOSFET electrically isolated from the first MOSFET and configured as a high-side switch to control a second LED;
d. a moisture detection circuit comprising a pair of metal pins embedded in an absorbent wick and electrically connected to the gate of the second MOSFET, the moisture detection circuit being configured to activate the second LED when electrical resistance between the electrodes falls below approximately 2.2 Mohms; and,
e. wherein the first and second MOSFETs operate independently to indicate low battery voltage and the presence of moisture, respectively.

16. The device of claim 15, wherein the moisture detection circuit and voltage detection circuit are mounted on a printed circuit board.

17. The device of claim 15, wherein the printed circuit board is positioned on the base of a toilet, and the wick extends upward from an adapter plate located beneath the toilet, such that the wick is in fluid communication with moisture accumulating below the toilet and electrically connected to the moisture detection circuit.

18. The device of claim 15, further comprising a protective cover enclosing the printed circuit board, the cover being formed from light-transmissive material or comprising a window aligned with one or more LEDs, such that illumination from the LEDs is visible through the cover.

19. The device of claim 16, wherein the wick is infused with a conductive agent to reduce electrical resistance when wet.

20. A method for detecting the presence of moisture under a toilet using an electronic device, the method comprising:
a. positioning a printed circuit board on the base of a toilet, the printed circuit board supporting a voltage monitoring circuit and a moisture detection circuit;
b. coupling a first MOSFET to a power supply and configuring it as a high-side switch to control a first LED;
c. electrically connecting the voltage monitoring circuit to the gate of the first MOSFET;
d. activating the first LED when the supply voltage falls below a predefined threshold;
e. positioning an adapter plate beneath the toilet;
f. extending an absorbent wick upward from the adapter plate into fluid communication with moisture accumulating in the adapter plate;
g. embedding a pair of electrodes within the wick and electrically connecting them to the gate of a second MOSFET, the second MOSFET and configured as a high-side switch to control a second LED;
h. activating the second LED when electrical resistance between the pair of electrodes falls below a predefined threshold; and,
i. wherein the first and second MOSFETs operate independently to indicate low battery voltage and the presence of moisture, respectively.
